(19) United States
(12) Patent Application Publication
(10) Pub. No.: US 2007/0185899 A1
(43) Pub. Date: Aug. 9, 2007

(54) Likelihood-based storage management

(75) Inventors: Aran Ziv, Natanya (IL); Itzhak Pomerantz, Kefar Saba (IL)

Correspondence Address: DR. MARK FRIEDMAN LTD.;C/o Bill Polkinghorn, 9003 Florin Way, Upper Marlboro, MD, 20772, US

(73) Assignee: MSYSTEMS LTD.

(21) Appl. No.: 11/642,897

(22) Filed: Dec. 21, 2006

Related U.S. Application Data
(60) Provisional application No. 60/760,829, filed on Jan. 23, 2006.

(51) Int. Cl. G06F 7/00

(52) U.S. Cl. 707/102

(57) ABSTRACT

A storage device including: a local storage for storing items on the storage device; a display for displaying prioritized menus of item entries, wherein the item entries represent high-use items and low-use items; a memory in which is stored: program code for setting criteria related to parameters external to the prioritized menus, the criteria being based on a usage likelihood of each item represented by each associated item entry; and program code for applying the criteria to modify a priority order of the item entries in the prioritized menus; and a CPU for executing the program code. Preferably, the memory has program code for conserving storage space in the local storage. Preferably, the memory has program code for conserving storage space in the local storage by moving the high-use items into, and the low-use items out of, the local storage according to the priority order.

This patent application claims the benefit of U.S. Provisional Patent Application No. 60/760,829 filed Jan. 23, 2006.

### FIELD AND BACKGROUND OF THE INVENTION

The present invention relates to systems and methods for optimizing the utilization of storage in a data-storage device by using protocol rules and external information to estimate the likelihood of use of listed items.

Storage systems that upload, dilute, and sort data according to the probability of use are well-known in the art of data-storage management. For example, the “Start>>>Programs” menu in the Microsoft® Windows® operating system sorts the applications according to when the applications were last used by a user. Another example is the “outgoing” calls in the memory of a mobile phone, which are typically stored in chronological order, so that most recent calls are listed first. A third example is email management systems that archive messages as they become older. All these prior-art sorting and diluting methods are based on the short-term history of use of an item by the user.

There is an inherent problem in sorting and diluting data according to the time elapsed since the data was last accessed, since this approach does not use other available parameters of the data, which are highly correlated to the probability that a specific item (i.e. portion of data) will be the next item to be requested by the user.

In order to make data-storage devices more user-friendly, it would be desirable to be able to sort and dilute stored data lists, which are serving as user-selectable menus, according to a plurality of additional parameters other than the history of data use by a user. Such a solution would enhance the usefulness of interactive menus by increasing the probability that the desired item would be found higher in the priority list when the item is needed.

### SUMMARY OF THE INVENTION

It is the purpose of the present invention to provide systems and methods for improving the probability that a listed item, listed among other items and needed by a user, will be readily available to the user.

For the purpose of clarity, several terms which follow are specifically defined for use within this application. The term “item entry” is used in this application to refer to a selectable item in a menu (i.e. user-selectable display list) of a device, such as a phone number to dial, a song name to play, or a book name to display. The term “item” is used in this application to refer to a file stored in a local storage of a device, typically represented by an item entry in a list or menu, unless “item” is qualified by an additional term such as “network item” which refers to a file stored in a network storage device.

The term “compression” is used in this application to refer to any operation that reduces the amount of storage space occupied by an item in the local storage, regardless of whether that operation is reversible without downloading data from outside the local storage or not. Compression, in the context of this application, includes, but is not limited to, any of the following methods:
(1) Compressing the item using lossless data-compression techniques, such as Lempel-Ziv techniques or the PKZIP® utility. In this case, reconstructing the item is possible locally without retrieving external information.
(2) Retaining a portion of the item, preferably the first portion of the item, and deleting the rest of the item. In this case, it is possible to immediately respond to a user request to partially display the item by locally retrieving the retained portion, but external retrieval is required for fully displaying the item.
(3) Retaining only header or indexing information of the item, and deleting the rest of the item. In this case, the item can appear in local lists and menus, but once selected, must be externally retrieved.

One of the essential features of the present invention is to sort items into two classes: items that the user is likely to access right away, and items that the user is not likely to access right away. Items that the user is likely to access right away are made more accessible than the other items. For example, an item that the user appears to have lost interest in can be compressed and archived somewhere until the user appears to regain interest.

The present invention pertains to managing items and sorting item entries in a limited-capacity storage device for maximum efficiency in accessing the items. According to the present invention, such a goal is achieved by estimating the likelihood of items being accessed based on external information that is available to a storage-management system for sorting the storage contents. Such external information is also available for deciding which items should be stored in “short-term” “immediate-access” storage, and which items can be stored remotely (e.g. in a slower-access but higher-capacity memory inside the device, in a server of which the device is a client, or in other long-term storage) in order to be retrieved by a user upon request.

The availability of an item to a user that needs to use the item is determined by two factors: (1) the position of the item entry in a list that allows the user to select the item, and (2) the status of the item in the local storage. The first factor determines the time it takes the user to express his/her request, and the second factor determines the time that it takes the system to fulfill the request. The user has to wait for both time periods in sequential order. From this, it is appreciated that the present invention relates to two distinct aspects of the process, namely, sorting and diluting.

Therefore, according to the present invention, there is provided for the first time a storage device including: (a) a local storage for storing items on the storage device; (b) a display for displaying at least one prioritized menu of item entries, wherein the item entries represent high-use items and low-use items; (c) a memory in which is stored: (i) program code for setting at least one criterion related to at least one parameter external to at least one prioritized menu, at least one criterion being based on a usage likelihood of each item represented by each associated item entry; and (ii) program code for applying at least one criterion to modify a priority order of the item entries in at least one prioritized menu; and (d) a CPU for executing the program code.

Preferably, the memory has further stored therein program code for conserving storage space in the local storage by compressing the low-use items in the local storage according to the priority order.

Most preferably, the memory is configured to select a compression type for the compressing based at least in part on the priority order.

Preferably, the memory has further stored therein program code for decompressing previously-compressed the low-use items upon a request for access of the previously-compressed low-use items.

Preferably, the memory has further stored therein program code for conserving storage space in the local storage by moving the high-use items into, and the low-use items out of, the local storage according to the priority order.

Preferably, at least one criterion is based on at least one criterion selected from the group consisting of: a time stamp, a day stamp, a date stamp, a popularity value of the item entries, text content from news sources, a schedule of a user, and personal preferences of a user.

Preferably, the device further includes: (e) a positioning system for determining a location of the storage device.

Most preferably, at least one criterion is based on the location.

According to the present invention, there is provided for the first time a mobile phone including the storage device of claim 1.

Preferably, at least one criterion is configured to incorporate an interpretation of recently-dialed phone numbers by the mobile phone.

According to the present invention, there is provided for the first time a storage device including: (a) a local storage for storing items on the storage device; (b) a memory in which is stored: (i) program code for setting at least one criterion, related to at least one external information element, based on a usage likelihood of each item; and (ii) program code for conserving storage space in the local storage by compressing low-use items in the local storage according to the usage likelihood; and (c) a CPU for executing the program code.

Preferably, the memory is configured to select a compression type for the compressing based at least in part on the usage likelihood.

Preferably, the memory has further stored therein program code for decompressing previously-compressed the low-use items upon a request for access of the previously-compressed low-use items.

Preferably, the memory has further stored therein program code for conserving storage space in the local storage by moving high-use items into, and the low-use items out of, the local storage according to the usage likelihood.

According to the present invention, there is provided for the first time a method for conserving storage space in a storage device, the method including the steps of: (a) providing an input list of item entries, wherein the item entries represent items; (b) providing at least one external information element derived from a source other than the input list; (c) providing at least one criterion dependent on at least one external information element; (d) applying at least one criterion on each item entry using at least one external information element as a parameter to calculate a usage likelihood of each item entry; and (e) compressing low-use items in the storage device according to the usage likelihood.

Preferably, at least one item resides outside a local storage of the storage device.

Preferably, the step of storing includes compressing corresponding items, represented by the item entries, according to a decrease in the usage likelihood of the item entries.

Preferably, the step of storing includes moving corresponding items, represented by the item entries, out of a local storage of the storage device according to a decrease in the usage likelihood of the item entries.

According to the present invention, there is provided for the first time a method for sorting information in a storage device, the method including the steps of: (a) providing an input list of item entries, wherein the item entries represent items; (b) providing at least one external information element derived from a source other than the input list; (c) providing at least one criterion dependent on at least one external information element; (d) applying at least one criterion on each item entry using at least one external information element as a parameter to calculate a usage likelihood of each item entry; (e) sorting the item entries, according to the usage likelihood, into a prioritized menu; and (f) displaying the prioritized menu on a display.

Preferably, at least one criterion is based on at least one criterion selected from the group consisting of: a time stamp, a day stamp, a date stamp, a popularity value of the item entries, text content from news sources, a schedule of a user, and personal preferences of a user.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified block diagram of a likelihood-based storage-management system, according to a preferred embodiment of the present invention;

FIG. 2 is a simplified flowchart of the system protocol for a likelihood-based storage-management system, according to a preferred embodiment of the present invention.

### DESCRIPTION OF THE PREFERRED EMBODIMENTS

The present invention relates to systems and methods for optimizing the utilization of storage in a data-storage device by using protocol rules and external information to estimate the likelihood of use of listed items. The principles and operation for optimizing the utilization of storage in a data-storage device, according to the present invention, may be better understood with reference to the accompanying description and the drawings.

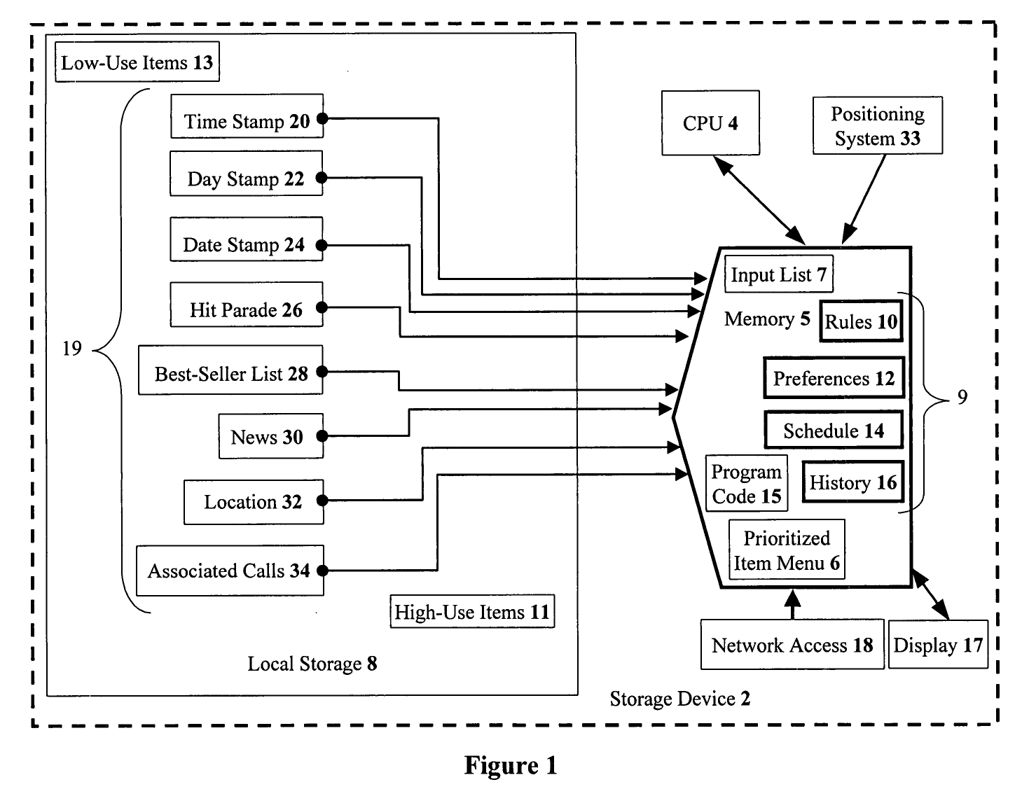

Referring now to the drawings, FIG. 1 is a simplified block diagram of a likelihood-based storage-management system, according to a preferred embodiment of the present invention. FIG. 1 shows a storage device 2 that has a CPU (central processing unit) 4 and a memory 5 that are used to maintain a prioritized item menu 6 based on an input list 7. Both prioritized item menu 6 and input list 7 are stored in memory 5. Storage device 2 can be, for example, a mobile phone, a PDA, a notebook computer, or some other mobile computing device. Prioritized item menu 6 is sorted and diluted, to include items that are likely to be requested by a user, in such a way that the items most likely to be requested enjoy the following two privileges:
(1) High-use items 11 that are more likely to be requested are kept in an immediate storage location of a local storage 8, ready for access, while low-use items 13 that are less likely to be requested are stored in a more remote location (or format), such as a less-accessible location (or format) in local storage 8, a slower-access but higher-capacity memory inside the device, or a server of which the device is a client (low-use items 13 may be compressed, according to the compression schemes mentioned above in the SUMMARY section, and may require being decompressed prior to being accessed).
(2) The item entries are kept at the top of the relevant selection menu. This menu can be, for example, a phone number list, a song list, a document list, and a digital booklist.

Memory 5 has, in a preferred embodiment of the present invention, several sets of relatively fixed criteria 9 that are implemented in screening input list 7 via program code 15 running on CPU 4. Criteria 9 include: a list of general rules 10 that are statistically and analytically found to be relevant to most users; a list of personal preferences 12 of a user which are manually entered into the system, or derived from the history of use via data-mining or other statistical tools; information from a schedule 14 of the user; and a history 16 of recent actions taken by the user, which are used to categorize the items as high-use items 11 or low-use items 13, similar to prior art methods. High-use items 11 and low-use items 13 can be documents, e-books, lists of phone numbers, for example. Prioritized item menu 6 is displayed on a display 17.

CPU 4 is also made aware, according to settings in preferences 12, from local storage 8, or through communication via a network access 18 (typically with a remote server), of background information that serves as a temporary context for CPU 4 to incorporate into criteria 9. One of the innovative features of the present invention is that criteria 9 are related to parameters (e.g. information) external to prioritized item menu 6. Network access 18 can optionally have wired and/or wireless communication modes. Typical contextual information 19 can include, for example: a time stamp 20, a day stamp 22, a date stamp 24, a hit parade 26 containing a list of the most popular music, a best-seller list 28 containing a list of the most popular books, news 30 containing recent news items, a location 32 of storage device 2 (determined via an optional positioning system 33, such as a GPS system, or the nearest base station receiving signal from network access 18 for wireless communication mode), and associated calls 34 containing calls entries associated (e.g. dialed, received, missed, etc.) with storage device 2. Associated calls 34 apply to embodiments in which storage device 2 is a mobile phone or some other device having telephony capabilities. To produce prioritized item menu 6, CPU 4 applies criteria 9 of the user, factoring in contextual information 19 described above, to obtain a weighted priority for each of the item entries.

Time stamp 20 can be used to alter the priority of phone numbers that are likely to be dialed at different times of the day. For example, during transit times to the office, a secretary's phone number will be high in prioritized item menu 6. In the last hour before an external meeting, the phone number of the host of the meeting will have a high-priority listing. Towards late afternoon, the phone numbers of a user's children will move up in prioritized item menu 6, as the children are out of school at that time, and it may be desirable to communicate with them.

Day stamp 22 is used to distinguish between phone numbers that are useful at work, and phone numbers that are useful in recreation over the weekend. Date stamp 24 is used for calls that do not follow other temporal patterns. For such calls, date stamp 24 indicates how recent the calls are and the frequency of the calls.

Hit parade 26 is used to upload (i.e. send data to the network) or download (i.e. receive data from the network) available music items that are popular with the general public. For upload, it is assumed that the user is likely to share his/her listening preferences with the public. For download, it is assumed that the user is likely to have common listening preferences with the majority of the public. In other words, it is assumed that the user is interested in receiving updated lists of popular items. In a similar way, e-book titles are uploaded to, or downloaded from, best-seller list 28; the corresponding e-books are available for request from e-book merchants.

News 30 is used to prioritize recent news items, based on settings in preferences 12, with item entries relevant to the user. Each entry of news 30 includes a caption of a news item. News 30 can be sports news, entertainment news, political news, or business news, for example. Settings in preferences 12 can be based on simple word-search protocols such as “sports hockey” or “business chemicals”, for example.

Similarly, location 32 is used to “float” (i.e. raise the priority in prioritized item menu 6) phone numbers that are likely to be needed in the area where the user is located. Using location 32 in such a configuration, location-sensitive situations will affect the priority listing. For example, when the user drives to a downtown office, the phone numbers of peers and colleagues in that office that he/she routinely talks to will float. In another example, when the user approaches a country club, phone numbers of friends that he usually exercises with will float.

Associated calls 34 can be added to prioritized item menu 6 in response to the current dialing attempt. Such a situation mainly applies to businesses. For example, if the user dials the phone number of a kosher fish restaurant in New York City, there is no way to predict what his/her next call will be. But if, within five minutes, the user dials another kosher fish restaurant, there is a high probability that the user is looking for a kosher fish restaurant, and that the user did not find what he/she wanted on the first (or second) call. It is conceivable that the user will appreciate if the next couple of phone numbers offered by storage device 2 in prioritized item menu 6 are for additional kosher fish restaurants in the same area, retrieved from an external directory such as a web version of the Yellow Pages (e.g. www.yellowpages.com) via network access 18. Clearly, these restaurant entries need not remain in prioritized item menu 6 for long; the entries are erased if a significant period of time (e.g. an hour) has elapse since the last fish restaurant was dialed.

Optionally, system coverage is not limited to applying the likelihood estimate method described above to items that are currently in local storage 8 only. The system can use the same method to evaluate items that are available externally via network access 18. The system can find, using web-scraping tools and other resources stored on storage device 2, downloadable items on websites. The system can also find, using its ability to synchronize with other storage devices on a network, downloadable items on the local network. If network items are found that have a significantly higher value for the user than local items on local storage 8, then corresponding network item entries can be retrieved and added to prioritized item menu 6 where the item entries are likely to be used. Item entries from prioritized item menu 6 that are found to have low priority can be removed from prioritized item menu 6 and archived.

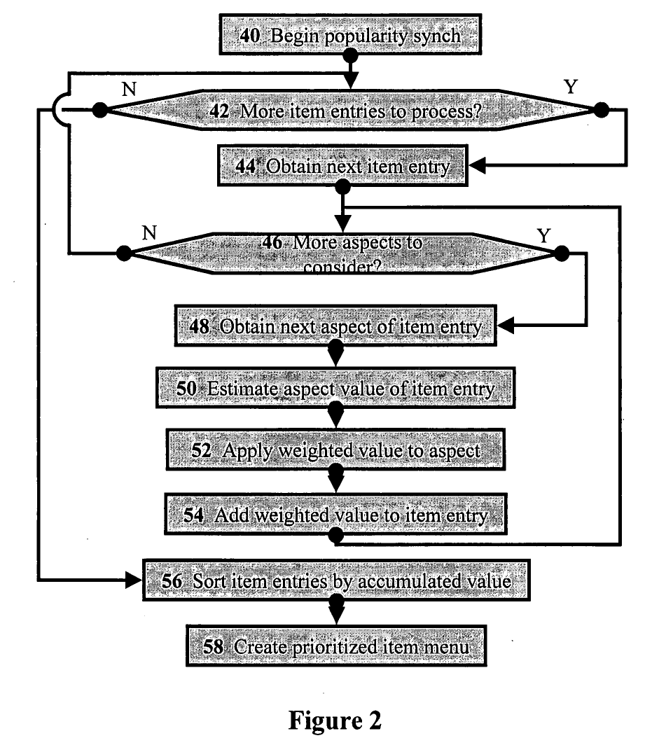

FIG. 2 is a simplified flowchart of the system protocol for a likelihood-based storage-management system, according to a preferred embodiment of the present invention. FIG. 2 shows an exemplary algorithmic scheme for sorting input list 7 (shown in FIG. 1) to become prioritized item menu 6 (shown in FIG. 1), based on criteria 9 and contextual information 19.

The system protocol begins (Step 40) by asking if all item entries in input list 7 (shown in FIG. 1) have been processed (Step 42). If there are more item entries to process, then the next item entry in input list 7 is obtained (Step 44). If there are more aspects of the next item entry to consider (Step 46), the next aspect of the item entry is obtained (Step 48). The aspect can be an element of criteria 9 available to CPU 4. CPU 4 obtains contextual information 19 that is relevant to the aspect of criteria 9, estimates the value of the aspect for the item entry (Step 50), and then applies a weighted value for the aspect (Step 52). The weighted value factors in preferences 12, since different aspects may have different significance for different users. The weighted value is then added to the accumulated value of the item entry (Step 54). The weighting system can be based on a variety of weighting schemes factoring in criteria 9. Optionally, the user can override the default weighting values by entering his/her own weighting values in preferences 12.

The system then proceeds to the next aspect (Step 46). When all aspects of the item entry have been considered and weighted, the system moves to the next item entry (Step 42). When all items have been processed, the system sorts the item entries according their accumulated values (Step 56), and then creates prioritized item menu 6 (Step 58). As mentioned above, input list 7 is not limited to item entries of items that reside in local storage 8 of storage device 2, which is physically accessed by the user (e.g. a mobile phone, a PDA, etc.). Input list 7 can also include external item entries that compete for a high position in prioritized item menu 6 of the user.

As a result of the method of the present invention, the limited storage-volume of storage device 2 can be optimized to retain the most useful information to the user. In addition, the user can access the information with minimal effort due to the sorting performed by the priority-ranking algorithm.

While the invention has been described with respect to a limited number of embodiments, it will be appreciated that many variations, modifications, and other applications of the invention may be made.

What is claimed is:

1. A storage device comprising:
(a) a local storage for storing items on the storage device;
(b) a display for displaying at least one prioritized menu of item entries, wherein said item entries represent high-use items and low-use items;
(c) a memory in which is stored:
(i) program code for setting at least one criterion related to at least one parameter external to said at least one prioritized menu, said at least one criterion being based on a usage likelihood of each said item represented by each associated said item entry; and
(ii) program code for applying said at least one criterion to modify a priority order of said item entries in said at least one prioritized menu; and
(d) a CPU for executing said program code.

2. The storage device of claim 1, wherein said memory has further stored therein program code for conserving storage space in said local storage by compressing said low-use items in said local storage according to said priority order.

3. The storage device of claim 2, wherein said memory is configured to select a compression type for said compressing based at least in part on said priority order.

4. The storage device of claim 1, wherein said memory has further stored therein program code for decompressing previously-compressed said low-use items upon a request for access of said previously-compressed low-use items.

5. The storage device of claim 1, wherein said memory has further stored therein program code for conserving storage space in said local storage by moving said high-use items into, and said low-use items out of, said local storage according to said priority order.

6. The storage device of claim 1, wherein said at least one criterion is based on at least one criterion selected from the group consisting of: a time stamp, a day stamp, a date stamp, a popularity value of said item entries, text content from news sources, a schedule of a user, and personal preferences of a user.

7. The storage device of claim 1, the device further comprising:
(e) a positioning system for determining a location of the storage device.

8. The storage device of claim 7, wherein said at least one criterion is based on said location.

9. A mobile phone comprising the storage device of claim 1.

10. The mobile phone of claim 9, wherein said at least one criterion is configured to incorporate an interpretation of recently-dialed phone numbers by the mobile phone.

11. A storage device comprising:
(a) a local storage for storing items on the storage device;
(b) a memory in which is stored:
(i) program code for setting at least one criterion, related to at least one external information element, based on a usage likelihood of each said item; and
(ii) program code for conserving storage space in said local storage by compressing low-use items in said local storage according to said usage likelihood; and
(c) a CPU for executing said program code.

12. The storage device of claim 11, wherein said memory is configured to select a compression type for said compressing based at least in part on said usage likelihood.

13. The storage device of claim 11, wherein said memory has further stored therein program code for decompressing previously-compressed said low-use items upon a request for access of said previously-compressed low-use items.

14. The storage device of claim 11, wherein said memory has further stored therein program code for conserving storage space in said local storage by moving high-use items into, and said low-use items out of, said local storage according to said usage likelihood.

15. A method for conserving storage space in a storage device, the method comprising the steps of:
(a) providing an input list of item entries, wherein said item entries represent items;
(b) providing at least one external information element derived from a source other than said input list;
(c) providing at least one criterion dependent on said at least one external information element;
(d) applying said at least one criterion on each said item entry using said at least one external information element as a parameter to calculate a usage likelihood of said each item entry; and
(e) compressing low-use items in the storage device according to said usage likelihood.

16. The method of claim 15, wherein at least one said item resides outside a local storage of the storage device.

17. The method of claim 15, wherein said step of storing includes compressing corresponding said items, represented by said item entries, according to a decrease in said usage likelihood of said item entries.

18. The method of claim 15, wherein said step of storing includes moving corresponding said items, represented by said item entries, out of a local storage of the storage device according to a decrease in said usage likelihood of said item entries.

19. A method for sorting information in a storage device, the method comprising the steps of:
(a) providing an input list of item entries, wherein said item entries represent items;
(b) providing at least one external information element derived from a source other than said input list;
(c) providing at least one criterion dependent on said at least one external information element;
(d) applying said at least one criterion on each said item entry using said at least one external information element as a parameter to calculate a usage likelihood of said each item entry;
(e) sorting said item entries, according to said usage likelihood, into a prioritized menu; and
(f) displaying said prioritized menu on a display.

20. The method of claim 19, wherein said at least one criterion is based on at least one criterion selected from the group consisting of: a time stamp, a day stamp, a date stamp, a popularity value of said item entries, text content from news sources, a schedule of a user, and personal preferences of a user.
